(19) United States
(12) Patent Application Publication
(10) Pub. No.: US 2012/0006855 A1
(43) Pub. Date: Jan. 12, 2012

(54) Liquid pump dispensing system for liquids having wide ranges of viscosities with no waste

(76) Inventor: Scott J. Ehrmann, West Milford, NJ (US)

(21) Appl. No.: 12/805,026

(22) Filed: Jul. 8, 2010

(51) Int. Cl. B67D 7/58; B67D 7/78

(52) U.S. Cl. 222/377; 222/464.7

(57) ABSTRACT

A liquid pump dispensing system for dispensing liquids having a wide range of viscosities is described as incorporating a unified approach to determining the dimensions of selected elements of a collection area as a function of the viscosity range of the liquid being dispensed. Four illustrative liquid viscosity ranges are described leading to defining specific values for the physical dimensions of several key elements of the dispensing technique. The dispensing rate is thereby optimized for the full range of viscosities contemplated. An additional complementary feature of slope ranges formed into a bottom shelf feeding into the collection area further optimizes the flow rate and assures a virtually waste free liquid dispensing regimen.

### TECHNICAL FIELD

The present invention relates generally to methods and apparatus for dispensing liquids having a wide range of viscosities, and more specifically to liquid dispensing by what is commonly known as ‘pump/spray bottle’ types, wherein certain parts of the pump mechanism and certain container dimensions are critically established. The present unique combination of dimensions at the intake location, or collection area, enable a broad range of liquid materials having a wide range of viscosities to be optimally dispensed, and further facilitates the dispensing of virtually all of the liquid material with no waste.

### BACKGROUND

Liquid dispensers of the spray bottle type are well known and conventional in the dispensing arts, and it has been an especially common practice in recent years to employ them to dispense various household liquids, personal care lotions and foodstuffs. Typical household liquids ideally suited to this type of dispensing include window cleaner sprays, kitchen countertop cleaning sprays and other similar low viscosity liquids. Typical personal health and beauty lotions include hand soaps and hand sanitizers, body sprays, lotions, perfumes, shampoos and other liquids in the mid-centipoise range; while typical foodstuffs include syrups and condiments. Higher viscosity liquids such as ketchup, mustard and cocoa butter and similar mid-to-high viscosity materials can and have been dispensed by means of pump-like mechanisms, but virtually always using arrangements that present both serious sanitation problems and equally negative material wastage problems.

High viscosity liquids in the range of 10,000 to 100,000 centipoise (cps), for example thick mustards or heavier creams, are often dispensed by squeeze bottles devices. These are cumbersome to use, most always require inverting of the container and produce a volume of material flow that is difficult to control. These squeeze devices generally dispense material or product that is too much, or too little, and the flow is often accompanied by unwanted splatter.

Plunger type dispensers of the type wherein a draw tube is positioned downwards into liquid, or product, housed in a more or less flat bottomed container, such as those found in fast food stores require a good deal of attention to prevent contamination of newly added liquid by residual liquid from previous refills which may be approaching rancidity. These plunger types are generally used for dispensing medium-to-high viscosity liquids such as cocktail sauce, mayonnaise, and the like.

The light-to-medium viscosity liquid dispensers avoid many of the above squeeze bottle or plunger/container problems, and therefore efficiency of dispensing and eliminating product waste become important considerations. It would be a significant advancement in the liquid dispensing art if a unitary dispensing device design and method could be employed to meet the needs of a wide array of liquid viscosities while providing an efficient, virtually waste free, and highly controllable dispensing capability. The unique features of present invention accomplish this.

Descriptions of typical prior art approaches to conventional means for dispensing liquids from a container using hand actuated pumping mechanisms may be found in a number of U.S. patents.

U.S. Pat. No. 5,366,119 to Kline discloses a liquid dispenser bottle employing a finger operated pump, wherein the bottle has a sump at its bottom into which a slotted draw tube is fully inserted and snugly fitted. An array of slots allows the liquid contents to drain down a sloped internal base into the sump for being sucked up into the draw tube.

Regarding the feature of a container showing a funnel-shaped bottom wall leading to a well, U.S. Design Pat. D 342,214 to Baxter is of general interest. See the cross-sectional view of FIG. 5 of this Vial Sleeve device. However, no written description detailing how the pictured vial functions exists.

U.S. Pat. No. 6,073,808 to Klima discloses a spray bottle dispenser including what appears to be one or more chemical concentrate reservoirs which may be positioned at its lower end, into which a downtube is positioned.

Additional U.S. patent documents are of general interest for their teachings of various spray bottle dispensing devices. These are U.S. Pat. No. 6,290,100 to Yacko et al., U.S. Pat. No. 5,799,500 to Kraus et al., and U.S. Pat. No. 4,470,576 to Cha et al.—plus U.S. Published Applications 2009/02984468 to Tom and 2005/0155990 to Gardiner.

It should be noted that these prior art patent documents show only various narrowly focused aspects or subcombinations of the features taught in the present invention. More significantly, not one of these prior art documents teaches nor suggests specific dimensions, or ranges of dimensions, that are operationally tied to the viscosities of the liquid they are designed to dispense. Additionally, while each of these prior art teachings show approaches that function more or less well for its intended purposes, they have not to date provided a unified approach that is applicable to the wide range of liquids under consideration. It is exactly these wide viscosity range dispensing needs that the present invention admirably meets.

### OBJECTS OF THE INVENTION

It is therefore a primary object of the present invention to provide improved methods and apparatus for dispensing liquids having a wide range of viscosities.

An additional object of the present invention is to provide improved methods and apparatus for dispensing liquid products having a wide range of viscosities while incurring virtually no waste of product.

A further object of the present invention is to define and quantify a specially configured collection area for dispensing liquids wherein the dimensions and relative positioning of distinct elements within the collection area are critically established based in substantial part on the viscosities of the product being dispensed.

A still further object of the present invention is to provide unified methods and apparatus for optimally dispensing liquid products or materials having wide ranges of viscosities using unique ranges of predetermined relationships between certain parameters of the dispensing process and apparatus and the product viscosities.

In preferred and alternate embodiments the size, location and spatial relationships between a draw tube positioned into a cylindrical well at the bottom of a liquid container and certain other elements are derived as a function of the viscosity of the liquid being dispensed. The various element parameters thus quantified lead to highly efficient, waste free dispensing, based largely on optimizing the volumetric size (and/or cross-sectional area) of a passageway in the collection area derived responsive to the centipoise value of the liquid being dispensed.

### BRIEF DESCRIPTION OF THE DRAWINGS

Additional objects and advantages of the invention will become apparent to those skilled in the art as the description proceeds with reference to the accompanying drawings, wherein:

FIG. 1 is a perspective view of a typical household cleaner spray-type dispensing container embodying the features of certain aspects of the present invention;

FIG. 2 is a side elevation of the spray-type dispensing container of FIG. 1 providing a clearer depiction of the liquid intake region or collection area at the bottom of the container;

FIG. 3 is a partial cross-sectional view taken along the lines 4-4′ of FIG. 2;

FIG. 4 is a chart illustrating typical viscosity values in centipoise units for a range of liquids amenable for use with the present invention; and

FIG. 5 is a highly schematic representation of the intake or collection area which aids in quantifying the dimensions of the various elements which incorporate the features and advantages of the present invention.

### BEST MODE FOR CARRYING OUT THE INVENTION

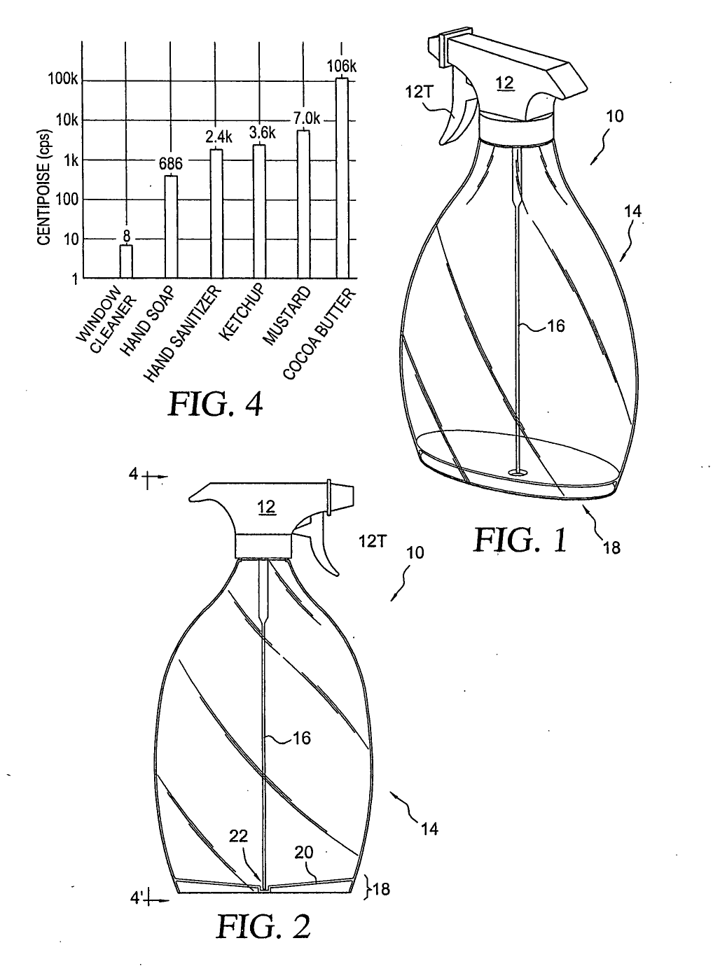

Referring now to FIGS. 1 and 2, there are shown a perspective view and a side elevational view, respectively, of a container 10 for carrying and dispensing various liquid products. The container 10, also referred to hereafter as a spray bottle dispenser or simply a spray bottle, includes a pump/spray assembly 12 which is threadedly affixed to the neck of a bottle 14. A pump tube 16 is affixed to the lower portion of the pump/spray assembly 12 and extends substantially vertically downward into a centrally disposed collection area depicted generally as the area 18 at the bottom of the container 10. In the preferred embodiment shown, the bottle 14 is thin walled and transparent and may be formed of polymeric materials by the well known blow molding process. In alternate embodiments, the bottle 14 may be made of opaque materials and may be formed by slightly different blow molding or other fabrication means commonly used for forming or shaping light weight and robust plastic materials, such as polyethylene or polypropylene.

Conventionally, the pump/spray assemble 12 may be finger actuated by a trigger 12T as shown. In an alternately embodiment (not shown), the pump/spray assembly may be of the push down, plunger actuated type, or other functionally equivalent types.

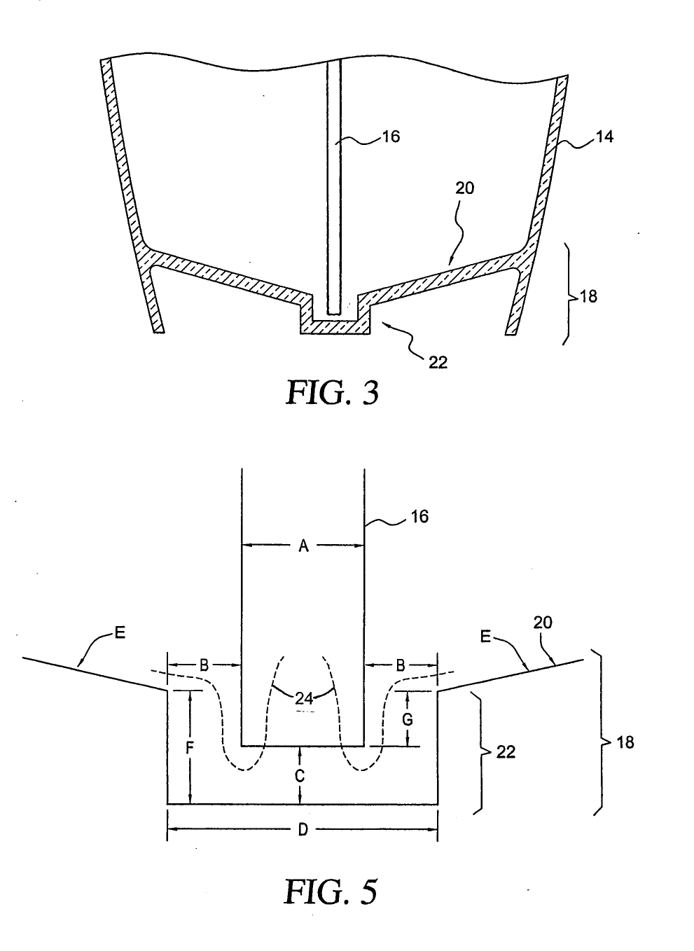

With particular reference now to the collection area 18 of FIG. 2 and the cross-sectional view of FIG. 3, note the downwardly sloped bottle bottom shelf 20 which extends disc-like from the inside wall of the bottle 14 to an outer edge of a cylindrical well 22. As will be detailed below, the important dimensions, spacing and relative locations of the elements in the collection area 18 are critically determined in order to achieve the unique benefits of the present invention. By close observation and experimentation, backed up by subsequent independent laboratory testing by the Sani-Pure Food Laboratories of Saddle Brook, N.J., the inventor has arrived at ranges of values for several key parameters for the collection area 18.

Consider now briefly the bar chart of FIG. 4 which shows the viscosities of a wide range of liquid products which are prime candidates for use in the present invention. Note that the viscosities depicted range from a low of 8 cps (centipoise units indicated on the vertical axis) for the common blue-tinted window cleaner, to 2,400 cps for over-the-counter brands of hand sanitizer, to a high of 106,000 cps for cocoa butter. For reference, water has a viscosity of 1 cps at 20° C. The lower viscosity materials or products are generally dispensed via easy to use spray bottles of the type shown in FIG. 1, while the higher viscosity materials or products are generally dispensed by other, typically less convenient, arrangements. For example, the squeeze bottle and non-sump, or well, pump dispensers used for the more dense liquids and creams defy efficient dispensing and ease of use leading to significant amounts of wasted product. The unused remnants also present health problems due to spoilage, as has been previously noted.

Turning now to FIG. 5 there is shown a highly schematic diagram of the collection area 18, particularly depicting the dimensions and relative positioning of the several elements it includes. Note that FIG. 5 (as well as FIG. 3) is not drawn strictly to scale but rather are enlarged and drawn to more clearly illustrate the structural and functional aspects of the elements of the collection area 18. For clarity, the letters A through G have been assigned to these key elements in order to support a tabular listing below. The cylindrical well 22 at the bottom of the area 18 is shown as having an inside diameter D and a depth F. The pump tube 16 is a relatively thin-walled, stiff element having an outside diameter A, which extends into the well 22 for a depth of G. Its interior axial channel or lumen has an inner diameter only slightly less than A. When inserted as shown, the outer dimension A of the pump tube 16 in combination with the diameter D, when inserted for the depth G produces a precisely defined liquid volumetric, or cross-sectionally defined passageway.

The passageway enables liquid flow along the dashed lines 24 through the washer-shaped area having B as its inlet flow dimension up and into the pump tube 16 through the space C between the floor of the well 22 and the lowermost extremity of the tube 16. The passageway so defined may be considered to visually resemble a shallow handleless cup with thick walls and a thick bottom.

The geometry of this arrangement lends itself perfectly to an additional intrinsically complementary feature of the present invention, namely, a gravity-assisted flow of the last amount of the liquid to be dispensed by virtue of the slope E of the shelf 20. It has been found that slopes E of 5° to 45°, when judiciously selected in combination with equally properly selected dimensions of A through G for the range of liquid viscosities shown in FIG. 4, produces a highly efficient dispensing method and apparatus. The slope E contributes to an increase in the flow rate. Upon selection of the proper physical dimensions including the slope E for the intended liquid viscosities—low, medium or high—an optimum flow rate is achieved which minimizes pump work required and assures that virtually all of the liquid in the container 10 is usefully dispensed.

Beyond the preferred embodiment wherein the pump tube 16 and the well 22 are circular in horizontal cross-section, alternate embodiments are contemplated. These two elements may, of course, be formed as matching pairs having cross-sections selected from the group including ovals, ellipses, rectangles, and other geometrical shapes; provided, however, that the passageway size/viscosity relationships are substantially those that resulted from the circular shaped elements.

Note that the bottle 14 is a component of the container 10, but that when needed, they may be referred to as interchangeable entities, especially when considered in light of the collection area which is at the lower end of both entities.

It has been determined that liquids having any value within the below four illustrative ranges of viscosities are optimally dispensed using the tabulated values for elements A-G as shown. In comparing the values tabulated below, note that the physical dimensions shown increase monotonically with increases in the viscosities of the liquid being dispensed. Also note that the dimensions of A-G should be considered as median values within a range of ±10%. For example, the value of dimension B shown as being 2 mm should be considered as being any value in the range of 1.8 mm to 2.2 mm.

For liquids with viscosities between approximately 1 and 1,000 cps:
A=Outside diameter of the pump tube.
B=2 mm all the way around the pump tube (from the outside of the tube to the inside of the well wall).
C=2 mm distance (from the bottom of the pump tube to the floor of the well).
D=Total diameter of the collection area, or well diameter (depends on tube size).
E=Five degree pitch angle or slope from the inside wall of the bottle to the outer edge of the well.
F=3 mm depth between the bottom of the pump tube to the floor of the well.
G=1 mm distance that the pump tube is inserted into the well.

For liquids with viscosities between approximately 1,001 and 5,000 cps:
A=Outside diameter of the pump tube.
B=5 mm all the way around the pump tube (from the outside of the tube to the inside of the well wall).
C=5 mm distance (from the bottom of the pump tube to the floor the well).
D=Total diameter of the collection area, or well diameter (depends on tube size).
E=Ten degree pitch angle or slope from the inside wall of the bottle to the outer edge of the well.
F=5 mm depth between the bottom of the pump tube to the floor of the well.
G=1 mm distance that the pump tube is inserted into the well.

For liquids with viscosities between approximately 5,001 and 10,000 cps:
A=Outside diameter of the pump tube.
B=5 mm all the way around the pump tube (from the outside of the tube to the inside of the well wall).
C=5 mm distance (from the bottom of the pump tube to the floor of the well).
D=Total diameter of the collection area, or well diameter (depends on tube size).
E=Fifteen degree pitch angle or slope from the inside wall of the bottle to the outer edge of the well.
F=6 mm depth between the bottom of the pump tube to the floor of the well.
G=1 mm distance that the pump tube is inserted into the well.

For liquids with viscosities between approximately 10,001 and 115,000 cps:
A=Outside diameter of the pump tube.
B=5 mm all the way around the pump tube (from the outside of the tube to the inside of the well wall).
C=5 mm distance (from the bottom of the pump tube to the floor of the well).
D=Total diameter of the collection area, or well diameter (depends on tube size).
E=Twenty degree pitch angle or slope from the inside wall of the bottle to the outer edge of the well.
F=7 mm depth between the bottom of the pump tube to the floor of the well.
G=2 mm distance that the pump tube is inserted into the well.

Although the invention has been described in terms of preferred and alternate embodiments, the invention should not be deemed limited thereto since modifications will readily occur to one skilled in the art. It is therefore to be understood that the appended claims are intended to cover all such modifications as fall within the true spirit and scope of the invention.

What is claimed is:

1. A system for dispensing liquids having a range of viscosities from a container via a vertically disposed pump draw tube positioned within a cylindrical well formed into a collection area at the container bottom, comprising:
a) a cylindrical well positioned at the bottom of said container having a depth of F and a diameter D;
b) a pump draw tube of indeterminate length having an outer diameter A and an axially disposed central lumen, said tube extending a depth G into said well, said depth F being greater that depth G by a distance C, said diameter D being greater than diameter A by a distance 2B;
c) a cup shaped passageway allowing flow of said liquid from said container up into said lumen for being dispensed, said passageway formed as the continuous space between said diameter D and diameter A and in communication with the continuous space between the depth F and depth G; and
d) whereby the passageway is sized such that dimensions B and C are increased in predetermined amounts corresponding to predetermined increases in the viscosity of the liquid being dispensed.

2. The system of claim 1 wherein said dimension B is selected from the range of values between 1.8 mm and 2.2 mm, said dimension C is selected from the range of values between 1.8 mm and 2.2 mm for dispensing liquids having viscosities in the range of 1 cps to 1,000 cps.

3. The system of claim 1 wherein said dimension B is selected from the range of values between 4.5 mm and 5.5 mm, said dimension C is selected from the range of values between 4.5 mm and 5.5 mm for dispensing liquids having viscosities in the range of 1,001 cps to 5,000 cps.

4. The system of claim 1 wherein said dimension B is selected from the range of values between 4.5 mm and 5.5 mm, said dimension C is selected from the range of values between 4.5 mm and 5.5 mm for dispensing liquids having viscosities in the range of 5,001 cps to 10,000 cps.

5. The system of claim 1 wherein said dimension B is selected from the range of values between 4.5 mm and 5.5 mm, said dimension C is selected from the range of values between 4.5 mm and 5.5 mm for dispensing liquids having viscosities in the range of 10,001 cps to 100,000 cps.

6. The system of claim 1 wherein said well having a cylindrical horizontal cross-section is formed as a well having a cross-section selected from the group including oval, elliptical and rectangular cross-sections.

7. A method for dispensing liquids having a range of viscosities from a container via a vertically disposed pump draw tube positioned within a cylindrical well formed into a collection area at the container bottom, comprising:
a) providing a substantially cylindrical well positioned at the bottom of said container, said well having a depth of F and a diameter D;
b) providing a pump draw tube of indeterminate length having an outer diameter A and an axially disposed central lumen, which tube extends a depth G into said well, said depth F being greater that depth G by a distance C, said diameter D being greater than diameter A by a distance 2B;
c) providing a cup shaped passageway allowing flow of said liquid from said container up into said lumen for being dispensed, said passageway formed as the continuous space between said diameter D and diameter A and in liquid communication with the continuous space between the depth F and depth G; and
d) whereby the passageway is sized such that dimensions B and C are increased monotonically in predetermined amounts corresponding to predetermined increases in the viscosity of the liquid being dispensed.

8. The method of claim 7 wherein said dimension B is selected from the range of values between 1.8 mm and 2.2 mm, said dimension C is selected from the range of values between 1.8 mm and 2.2 mm for dispensing liquids having viscosities in the range of 1 cps to 1,000 cps.

9. The method of claim 7 wherein said dimension B is selected from the range of values between 4.5 mm and 5.5 mm, said dimension C is selected from the range of values between 4.5 mm and 5.5 mm for dispensing liquids having viscosities in the range of 1,001 cps to 5,000 cps.

10. The method of claim 7 wherein said dimension B is selected from the range of values between 4.5 mm and 5.5 mm, said dimension C is selected from the range of values between 4.5 mm and 5.5 mm for dispensing liquids having viscosities in the range of 5,001 cps to 10,000 cps.

11. The method of claim 7 wherein said dimension B is selected from the range of values between 4.5 mm and 5.5 mm, said dimension C is selected from the range of values between 4.5 mm and 5.5 mm for dispensing liquids having viscosities in the range of 10,001 cps to 100,000 cps.

12. The method of claim 7 wherein said cylindrical well is formed as a well having a cross-section selected from the group including oval, elliptical and rectangular cross-sections.

13. A spray bottle liquid dispensing apparatus for dispensing liquids having a wide range of viscosities using predetermined relationships between key physical parameters of the dispensing apparatus and the viscosities of the liquid being dispensed, comprising:
a) a container having a removable bottle for containing the liquid to be dispensed, said bottle having a collection area at its bottom;
b) a pump/spray means affixed at to an upper end portion of said bottle;
c) a pump draw tube affixed to a lower portion of said pump/spray means and vertically disposed into a cylindrical well element;
d) said well element having a depth of F and a diameter D and positioned at the bottom of said container;
e) said pump draw tube of indeterminate length having an outer diameter A and an axially disposed central lumen, which tube extends a depth G into said well, said depth F being greater that depth G by a distance C, said diameter D being greater than diameter A by a distance B;
f) a cup shaped passageway allowing flow of said liquid from said container up into said lumen for being dispensed, said passageway formed as the continuous space between said diameter D and diameter A and in liquid communication with the continuous space between the depth F and depth G; and
f) whereby the passageway is sized such that dimensions B and C are increased in predetermined amounts corresponding to predetermined increases in the viscosity of the liquid being dispensed.
